(19) United States
(12) Patent Application Publication
(10) Pub. No.: US 2014/0001409 A1
(43) Pub. Date: Jan. 2, 2014

(54) POLYAMIDE-IMIDE RESIN FILM AND SEAMLESS BELT INCLUDING THE RESIN FILM

(71) Applicant: NITTO DENKO CORPORATION, Osaka (JP)

(72) Inventors: Hisae KITAGAWA, Osaka (JP); Shunsuke MASAKI, Osaka (JP)

(21) Appl. No.: 13/927,897

(22) Filed: Jun. 26, 2013

(30) Foreign Application Priority Data
Jun. 27, 2012 (JP) 2012-144174
May 2, 2013 (JP) 2013-096802

(51) Int. Cl. H01B 1/20

(52) U.S. Cl. CPC H01B 1/20
USPC 252/500

(57) ABSTRACT

A polyamide-imide resin composition according to embodiment of the present invention, including a polyamide-imide resin obtained by causing acid components (A) containing a dimer acid and a polyisocyanate component (B) to react with each other, wherein a ratio of the dimer acid in the acid components (A) is 3 mol % to 55 mol %.

This application claims priority under 35 U.S.C. Section 119 to Japanese Patent Applications No. 2012-144174 filed on Jun. 27, 2012, which is herein incorporated by references.

### BACKGROUND OF THE INVENTION

1. Field of the Invention

The present invention relates to a polyamide-imide resin film and a seamless belt including the resin film.

2. Description of the Related Art

A polyimide resin and a polyamide-imide resin have been generally used as resins each having heat resistance in various belts (such as an intermediate transfer belt) to be used in, for example, image-forming apparatus of an electrophotographic system such as a copying machine and a printer (for example, Japanese Patent Application Laid-open No. 2003-261767). However, those resins each involve the following problem. The resins are liable to adsorb moisture owing to their molecular structures. For example, the intermediate transfer belt constituted of a polyamide-imide resin film is liable to cause a transfer shift owing to the deformation of the belt due to moisture absorption. Even the structure of the polyamide-imide resin disclosed in Japanese Patent Application Laid-open No. 2003-261767 has not been sufficiently optimized and hence the adsorption of moisture cannot be suppressed to a practically acceptable level. Such problem becomes more remarkable in an image-forming apparatus required to have higher accuracy.

In addition, the problem becomes more remarkable in a film required to have conductivity (such as a film containing a conductive filler) as well. An attempt has been made to solve the problem by improving a production step while paying attention to the surface resistivity and hygroscopic expansion coefficient of the polyamide-imide resin film (for example, Japanese Patent Application Laid-open No. 2004-233519). However, the method has room for improvement because of, for example, the following reason. It is difficult to control the production step by the method.

### SUMMARY OF THE INVENTION

An object of the present invention is to provide a polyamide-imide resin film excellent in dimensional stability.

The inventors of the present invention have made extensive studies, and as a result, have found that the object can be achieved by using the following polyamide-imide resin composition. Thus, the inventors have completed the present invention.

A polyamide-imide resin film according to embodiment of the present invention, including: a polyamide-imide resin; and a conductive filler, wherein: the polyamide-imide resin is obtained by causing acid components (A) containing a dimer acid and a polyisocyanate component (B) to react with each other; and a ratio of the dimer acid in the acid components (A) is 3 mol % to 55 mol %.

In an embodiment of the present invention, the acid components (A) include a hydrogenated dimer acid.

In an embodiment of the present invention, the polyisocyanate component include an aromatic diisocyanate.

In an embodiment of the present invention, the acid components (A) further include a tricarboxylic anhydride and a ratio of the tricarboxylic anhydride in the acid components (A) is 90 mol % to 97 mol %.

In an embodiment of the present invention, the conductive filler includes a polyaniline.

In an embodiment of the present invention, the polyamide-imide resin film has a hygroscopic expansion coefficient of 70 ppm/% RH or less.

According to another aspect of the present invention, a seamless belt is provided. The seamless belt includes the polyamide-imide resin film.

The polyamide-imide resin film of the present invention can be obtained by using a polyamide-imide resin composition containing: the polyamide-imide resin using the acid components containing a specific amount of the dimer acid; and the conductive filler. While the dimensional stability of an ordinary resin film containing the conductive filler may reduce, the polyamide-imide resin film of the present invention can exert excellent dimensional stability in spite of the fact that the film contains the conductive filler. Further, the following polyamide-imide resin film can be provided. The polyamide-imide resin film is excellent in dimensional stability even under an environment where a humidity change may occur because the film contains the polyamide-imide resin. Accordingly, the use of the polyamide-imide resin film of the present invention as a seamless belt enables the belt to drive stably and to maintain desired performance. For example, the application of the polyamide-imide resin film of the present invention to an intermediate transfer belt can suppress the deformation of the belt and can maintain good image-forming performance. In addition, the polyamide-imide resin film of the present invention can be produced with no need for any complicated step.

### DETAILED DESCRIPTION OF THE PREFERRED EMBODIMENTS

### A. Polyamide-Imide Resin Composition

A polyamide-imide resin film of the present invention can be obtained by using a polyamide-imide resin composition containing a polyamide-imide resin and a conductive filler. The polyamide-imide resin is obtained by causing acid components (A) containing a dimer acid and a polyisocyanate component (B) to react with each other. The use of the polyamide-imide resin using the acid components (A) containing the dimer acid can provide the following polyamide-imide resin film: the polyamide-imide resin film has excellent dimensional stability in spite of the fact that the film contains the conductive filler. Further, the use of the polyamide-imide resin composition can provide a polyamide-imide resin film capable of exerting excellent dimensional stability even under an environment where a humidity change may occur.

### <A-1. Polyamide-Imide Resin>

The polyamide-imide resin employed in the present invention is obtained by causing any appropriate acid components (A) containing the dimer acid and any appropriate polyisocyanate component (B) to react with each other. In the present invention, the isocyanate method is employed because of its excellent working efficiency.

A compounding ratio between the acid components (A) and the polyisocyanate component (B) to be used in the synthesis of the polyamide-imide resin can be set to any appropriate ratio. The compounding ratio between the acid components (A) and the polyisocyanate component (B) is preferably such that the amount of the polyisocyanate component (B) is 0.5 mole to 2.0 moles with respect to 1 mole of the acid components (A), and the compounding ratio is more preferably such that the amount of the acid components (A) is equivalent to that of the polyisocyanate component (B).

The number-average molecular weight of the polyamide-imide resin is preferably 5,000 to 50,000, more preferably 8,000 to 30,000. When the number-average molecular weight of the polyamide-imide resin falls within the range, film forming can be easily performed.

<A-1-1. Acid Components (A)>

The dimer acid and any appropriate other acid component are used as the acid components (A).

<A-1-1-1. Dimer Acid>

The dimer acid is a compound obtained by an intermolecular polymerization reaction between two or more unsaturated fatty acids. The use of the dimer acid as the acid components can provide the following film: the film has excellent dimensional stability in spite of the fact that the film contains the conductive filler. In addition, the use of the dimer acid as the acid components results in the incorporation of a long-chain alkyl group having high hydrophobicity into the molecular structure of the polyamide-imide resin. Therefore, the adsorption of moisture to the film may be suppressed as compared with a polyamide-imide resin using only a component having an aromatic group. Accordingly, the film using the polyamide-imide resin composition may be excellent in dimensional stability even under an environment where a humidity change may occur. Further, the polyamide-imide resin into which the dimer acid has been introduced can provide a film excellent in flexibility (such as rupture elongation). Accordingly, the film can be easily processed into, for example, a seamless belt.

Examples of the unsaturated fatty acids include linear or branched unsaturated fatty acids each having 8 or more (preferably 16 to 22, more preferably 16 to 20, still more preferably 18) carbon atoms. Specific examples of the unsaturated fatty acids include oleic acid, linoleic acid, elaidic acid, palmitoleic acid, linolenic acid, 3-octenoic acid, and 10-undecenoic acid. Of those, oleic acid is preferred. The use of a long-chain dimer acid obtained by bonding two molecules of oleic acid makes the effect significant. In addition, the use of the dimer acid can provide a polyamide-imide resin composition capable of providing a film additionally excellent in mechanical characteristics such as a tensile strength as well as flexibility (rupture elongation).

The number of carbon atoms of the dimer acid is preferably 16 or more, more preferably 32 to 40, still more preferably 36. The structure of the dimer acid is not particularly limited, and any one of an acyclic structure, a monocyclic structure, a polycyclic structure, and an aromatic ring-type structure may be used. Only a dimer acid having any one of the structures may be used as the dimer acid, or two or more kinds of dimer acids having different structures may be used in combination. The dimer acid may be a hydrogenated dimer acid. The hydrogenated dimer acid is preferably used as the dimer acid. The hydrogenated dimer acid can be used in a state of being free of a double bond having reaction activity and hence the polymerization reaction of the polyamide-imide resin is stable. As a result, a polyamide-imide resin composition excellent in storage stability can be obtained. The hydrogenated dimer acid and a dimer acid that is not hydrogenated may be used in combination as the dimer acid.

As the dimer acid, a commercially available dimer acid may be used. Examples thereof include a “PRIPOL” series manufactured by Croda Japan, a “HARIDIMER” series manufactured by Harima Chemicals, an “EMPOL” series manufactured by BASF Japan Ltd., and a “Tsunodyme” series manufactured by TSUNO CO., LTD. Those commercially available dimer acids may be used alone or in combination. Each of the commercially available dimer acids can typically contain small amounts of a monomer acid and a trimer acid in addition to the dimer acid. When any one of the commercially available dimer acids is used, the acid can be used as it is without being further subjected to a purifying step or the like.

A ratio of the dimer acid in the acid components (A) is 3 mol % or more, preferably 7 mol % or more, more preferably 15 mol % or more. When the ratio of the dimer acid in the acid components (A) is 3 mol % or more, a polyamide-imide resin capable of providing a film additionally excellent in dimensional stability even under an environment where a humidity change may occur can be obtained. In addition, the ratio of the dimer acid in the acid components (A) is 55 mol % or less, more preferably 52 mol % or less, more preferably 45 mol % or less. When the ratio of the dimer acid in the acid components (A) is 55 mol % or less, the pot life of a solution (varnish) containing the polyamide-imide resin is lengthened and hence high polymerization reactivity of the polyamide-imide resin can be secured. Further, the mechanical characteristics of the resultant film such as a modulus of elasticity can further improve.

<A-1-1-2. Acid Component Except Dimer Acid>

Any appropriate acid component can be used as the acid component except the dimer acid. Examples of the acid component except the dimer acid include a tricarboxylic anhydride, a tetracarboxylic dianhydride, an aromatic dicarboxylic acid, an alicyclic dicarboxylic acid, and an aliphatic dicarboxylic acid. Specific examples thereof include: tricarboxylic anhydrides such as trimellitic anhydride and cyclohexanetricarboxylic anhydride; tetracarboxylic dianhydrides such as pyromellitic anhydride, biphenyltetracarboxylic dianhydride, and oxydiphthalic anhydride; aromatic dicarboxylic acids such as terephthalic acid and isophthalic acid; alicyclic dicarboxylic acids such as cyclohexanedicarboxylic acid; and aliphatic dicarboxylic acids such as adipic acid and sebacic acid. The acid components except the dimer acid may be used alone or in combination. A tricarboxylic anhydride is preferred as the acid component except the dimer acid in terms of reactivity, solubility, heat resistance, and a cost. In addition, the use of the tricarboxylic anhydride can provide a polyamide-imide resin whose moisture absorption characteristic is suppressed. Trimellitic anhydride can be more preferably used because of the following reasons: trimellitic anhydride has high general-purpose property and easily reduces the cost. In one embodiment, the ratio of the tricarboxylic anhydride in the acid components (A) is preferably 45 mol % to 97 mol %, more preferably 90 mol % to 97 mol %. In such embodiment, the ratio of the dimer acid in the acid components (A) is preferably 3 mol % to 55 mol %, more preferably 3 mol % to 10 mol %.

<A-1-2. Polyisocyanate Component (B)>

Any appropriate isocyanate component can be used as the polyisocyanate component (B). Examples of the polyisocyanate component (B) include an aromatic diisocyanate, an aliphatic isocyanate, and an alicyclic isocyanate. Specific examples thereof include: aromatic diisocyanates such as 4,4′-diphenylmethane diisocyanate, tolylene diisocyanate, tetramethylxylene diisocyanate, and 3,3′-dimethylbiphenyl-4,4′-diisocyanate; aliphatic diisocyanates such as hexamethylene diisocyanate; and alicyclic diisocyanates such as isophorone diisocyanate, hydrogenated xylylene diisocyanate, norbornene diisocyanate, and dicyclohexylmethane diisocyanate. An aromatic diisocyanate is preferred as the polyisocyanate component (B). The use of the aromatic diisocyanate can provide a polyamide-imide resin capable of forming a film excellent in mechanical strengths such as a modulus of elongation and a breaking strength. The isocyanates may be used alone or in combination.

<A-1-3. Method of Producing Polyamide-Imide Resin>

The polyamide-imide resin can be obtained by causing the acid components (A) containing the dimer acid and the polyisocyanate component (B) to react with each other in any appropriate solvent. Examples of the solvent include N-methyl-2-pyrrolidone, N,N-dimethylacetamide, and γ-butyrolactone. Those solvents may be used alone or as a mixture. The reaction temperature and the reaction time have only to be appropriately set. For example, the reaction temperature can be set to 100° C. to 250° C. and the reaction time can be set to 3 hours to 20 hours.

A catalyst may be used for the synthesis of the polyamide-imide resin as required. Any appropriate catalyst may be used as the catalyst. Examples of the catalyst include diazabicycloundecene, triethylenediamine, potassium fluoride, and cesium fluoride. The addition amount of the catalyst can be set to any appropriate value depending on, for example, the loading amounts of the materials to be used in the reaction and the reaction conditions.

<A-2. Conductive Filler>

Any appropriate conductive filler can be used as the conductive filler. Examples of the conductive filler include: inorganic compounds such as carbon black, aluminum, nickel, tin oxide, and potassium titanate; and conductive polymers such as a polyaniline and a polypyrrole. A polyaniline is preferred as the conductive filler. The use of the polyaniline can impart good electrical characteristics even when its addition amount is relatively small, and can prevent adverse effects on characteristics intrinsic to the resin. Further, the polyaniline can be uniformly dispersed in the polyamide-imide resin composition and can prevent a variation in its electric resistance as well. The polyamide-imide resin allows a solvent in the resin composition to be removed more easily than a conventional polyamide-imide resin does. Accordingly, even an organic substance or the like that decomposes at a high temperature like the polyaniline can be suitably used as the conductive filler. The conductive fillers may be used alone or in combination. In addition, the polyaniline and a conductive filler except the polyaniline may be used in combination.

The content of the conductive filler in the polyamide-imide resin composition can be set to any appropriate value depending on desired electrical characteristics. The content of the conductive filler is preferably 1 part by weight to 20 parts by weight with respect to 100 parts by weight of the polyamide-imide resin.

<A-2-1. Polyaniline>

The polyaniline has only to be a polyaniline capable of imparting desired electrical characteristics to a film to be obtained, and any appropriate polyaniline can be adopted. For example, the polyaniline may be a polyaniline in a de-doped state (emeraldine base state), may be a polyaniline in a doped state, or may be a self-doped polyaniline. The polyaniline in a doped state is preferably used as the polyaniline. The polyaniline in a doped state is obtained by, for example, bringing a dopant into contact with any appropriate polyaniline in a de-doped state to dope the polyaniline with the dopant.

<A-2-1-1. Polyaniline in De-Doped State>

A polyaniline soluble in an organic solvent can be preferably used as the polyaniline in a de-doped state. This is because the polyaniline can be easily mixed with the polyamide-imide resin and hence facilitates the preparation of the polyamide-imide resin composition. The polyaniline in a de-doped state has, as a repeating unit, a basic skeleton in which a quinonediamine structural unit and a phenylenediamine structural unit are present at substantially equal molar fractions. A preferred specific example of such polyaniline is a polyaniline described in Japanese Patent Application Laid-open No. Hei 3-28229. The description is incorporated herein by reference. The polyaniline is soluble in an organic solvent such as N-methyl-2-pyrrolidone when in a de-doped state, and is excellent in mixability with the resin. A commercial product may be used as the polyaniline. The commercial polyaniline is, for example, a polyaniline available under the trade name “Panipol PA” from Panipol.

<A-2-1-2. Dopant>

The dopant is preferably a protonic acid. A protonic acid having an acid dissociation constant, i.e., pKa value of 4.8 or less is more preferred because stable conductivity is obtained. Specific examples of such protonic acid include: inorganic acids such as hydrochloric acid, sulfuric acid, and nitric acid; sulfonic acid compounds such as dodecylbenzenesulfonic acid, an allylsulfonic acid, xylenesulfonic acid, ethanesulfonic acid, and chlorobenzenesulfonic acid; organic carboxylic acid compounds; and phosphoric acid compounds such as phosphoric acid, phosphorous acid, hypophosphorous acid, and phenylphosphonic acid. Of those, dodecylbenzenesulfonic acid is preferred in terms of its ease of availability, handleability, and processability. The addition amount of the dopant can be set to any appropriate addition amount. The addition amount of the dopant is, for example, 1.0 mole to 4.0 moles, preferably 1.0 mole to 2.0 moles with respect to 1 mole of the polyaniline in a de-doped state.

<A-2-1-3. Method of Preparing Polyaniline in Doped State>

The polyaniline in a doped state can be prepared by imparting conductivity to the polyaniline in a de-doped state with the dopant according to any appropriate method. The polyaniline in a doped state can be obtained by, for example, kneading the polyaniline in a de-doped state and any appropriate dopant under heating. An apparatus that can be used in the kneading and heating is, for example, a closed kneading apparatus or batch-type kneading apparatus such as a Banbury mixer, a kneader, or a roll, or a continuous kneading apparatus such as a uniaxial extruder or a biaxial extruder. A kneading temperature and kneading time during the heating and kneading are, for example, 120° C. to 200° C. and 1 minute to 60 minutes, respectively.

<A-3. Other Additive>

The polyamide-imide resin composition can further contain any appropriate additive in addition to the polyamide-imide resin and the conductive filler. Examples of the additive include: a coupling agent; silica; a metal oxide such as alumina or titania; an inorganic filler such as clay or mica; and a surfactant for dispersing these additives in the polyamide-imide resin composition. Those additives may be used alone or in combination.

The solid matter content of the polyamide-imide resin composition can be appropriately set depending on a method of producing the film. The solid matter content of the polyamide-imide resin composition can be set to, for example, 15 wt % to 35 wt %. The solid matter content of the polyamide-imide resin composition can be adjusted by adding any appropriate organic solvent to the reaction solution of the polyamide-imide resin. For example, the solvent to be used in the reaction of the polyamide-imide resin can be used as the organic solvent.

<A-4. Method of Preparing Polyamide-Imide Resin Composition>

The polyamide-imide resin composition can be prepared by any appropriate method. The composition can be obtained by, for example, mixing the polyamide-imide resin and the conductive filler in any appropriate solvent. In addition, when the polyaniline is used as the conductive filler, the polyamide-imide resin composition may be prepared by mixing a polyaniline solution, which has been prepared by mixing the kneaded product of the polyaniline in a de-doped state and the dopant with any appropriate organic solvent, and the polyamide-imide resin. As the organic solvent, a polar solvent may be used, a non-polar solvent may be used, or a mixture thereof may be used. Examples of the polar solvent include N-methyl-2-pyrrolidone and N,N-dimethylacetamide. Examples of the non-polar solvent include toluene and xylene.

The solid matter content of the polyaniline solution can be set to any appropriate value depending on a method of producing the film and a desired solid matter content of the polyamide-imide resin composition. The solid matter content of the polyaniline solution is, for example, 0.5 wt % to 25 wt %, preferably 1 wt % to 20 wt %.

### B. Polyamide-Imide Resin Film

The polyamide-imide resin film of the present invention is obtained by using the polyamide-imide resin composition, and contains the polyamide-imide resin and the conductive filler. Accordingly, the polyamide-imide resin film of the present invention has excellent dimensional stability in spite of the fact that the film contains the conductive filler. In addition, the polyamide-imide resin film of the present invention has excellent dimensional stability even under an environment where a humidity change may occur. Therefore, the film can be suitably used in a seamless belt required to have excellent dimensional stability even under an environment where a humidity change may occur such as an intermediate transfer belt, fixing belt, or conveying belt to be used in an image-forming apparatus of an electrophotographic system such as a copying machine.

The polyamide-imide resin film of the present invention has a hygroscopic expansion coefficient of preferably 70 ppm % RH or less, more preferably 50 ppm % RH or less. In addition, the hygroscopic expansion coefficient is preferably 1 ppm % RH or more for practicality. When the hygroscopic expansion coefficient of the polyamide-imide resin film falls within the range, the film is excellent in dimensional stability even under an environment where a humidity change may occur. The term “hygroscopic expansion coefficient” as used herein refers to a value calculated as described below. A sample measuring 25 mm by 4 mm punched out of the film is set in an apparatus for thermomechanical analysis whose chuck-to-chuck distance has been set to 20 mm (such as an apparatus available under the trade name “TMA 4000SA” from Bruker AXS). After that, the sample is sufficiently dried under an environment having a temperature of 30° C. and a humidity of 20% RH. Next, the humidity is increased to 80% RH and then the hygroscopic expansion coefficient is calculated from a dimensional change with respect to an initial length at the time of measurement under the following conditions according to the following equation.

Measurement mode: A tension method
Tension load: 4 g
Measurement atmosphere: A temperature of 30° C. and a humidity of 80% RH
Measuring time: 660 minutes

Hygroscopic expansion coefficient=(elongation of sample/initial length of sample)/amount of humidity change

The polyamide-imide resin film of the present invention preferably further has excellent mechanical characteristics. When the polyamide-imide resin film of the present invention has excellent mechanical characteristics, the film can be suitably used in an application where a mechanical strength is required. For example, the tensile strength, rupture elongation, and modulus of elongation of the polyamide-imide resin film of the present invention preferably fall within the following ranges. The tensile strength of the polyamide-imide resin film of the present invention is preferably 55 MPa to 130 MPa. The rupture elongation of the polyamide-imide resin film of the present invention is preferably 5% to 40%. The modulus of elongation of the polyamide-imide resin film of the present invention is preferably 1,000 MPa to 2,500 MPa. The terms “tensile strength,” “rupture elongation,” and “modulus of elongation” as used herein each refer to a value obtained by subjecting a sample, which has been punched out of the resin film having a thickness of 50 μm into a dumbbell No. 3 shape, to measurement with a Tensilon Universal Tester (manufactured by, for example, Toyo Baldwin) at a tension speed of 100 mm/min.

The thickness of the polyamide-imide resin film of the present invention can be appropriately set depending on applications and the like. The thickness of the polyamide-imide resin film of the present invention is, for example, 25 μm to 150 μm, preferably 50 μm to 100 μm.

The polyamide-imide resin film of the present invention can be produced by any appropriate method. The polyamide-imide resin film of the present invention can be obtained by, for example, applying the polyamide-imide resin composition to any appropriate base material to produce a coating film and removing a solvent from the coating film to dry the coating film. Examples of the base material include glass, a metal, and a polymer film. Any appropriate method can be employed as a method of applying the polyamide-imide resin composition to the base material. The method of applying the polyamide-imide resin composition to the base material is, for example, a solvent casting method. A drying temperature for the polyamide-imide resin film is, for example, 100° C. to 300° C., preferably 150° C. to 250° C. In addition, a drying time is preferably 10 minutes to 60 minutes.

In addition, a resin film for a seamless belt can be produced by using a cylindrical mold as the base material. The resin film for a seamless belt is produced by, for example, supplying the polyamide-imide resin composition into the cylindrical mold to form a coating film on the inner surface of the mold and then removing a solvent by a heating treatment to dry the coating film. Any appropriate method is adopted as a method of forming the coating film at the time of the production of the resin film for a seamless belt. Examples thereof include: a method involving supplying an application liquid into the mold, which is rotating, and turning the liquid into a uniform coating film with a centrifugal force; a method involving inserting a nozzle along the inner surface of the mold and ejecting the application liquid from the nozzle into the mold, which is rotating, to spirally apply the liquid while running the nozzle or the mold; a method involving roughly performing the spiral application and then running a running body (of a bullet shape or a spherical shape) having a constant clearance between itself and the mold; a method involving immersing the mold in the application liquid to form an applied film on its inner surface, followed by film forming with a cylindrical die or the like; and a method involving supplying the application liquid to one end portion of the inner surface of the mold and then running the running body (of a bullet shape or a spherical shape) having a constant clearance between itself and the mold. A temperature for the heating treatment is preferably 100° C. to 300° C., more preferably 150° C. to 250° C. A time period for the heating treatment is preferably 10 minutes to 60 minutes.

The surface resistivity of the polyamide-imide resin film of the present invention can be set to any appropriate value depending on applications. When the resin film is used as, for example, an intermediate transfer belt, its surface resistivity is 1×10⁶ ohms per square (Ω/□) to 1×10¹⁵Ω/□, preferably 1×10⁹Ω/□ to 1×10¹⁴ Ω/□.

The volume resistivity of the polyamide-imide resin film of the present invention can be set to any appropriate value depending on applications. When the resin film is used as, for example, an intermediate transfer belt, its volume resistivity is, for example, 1×10⁶ Ω·cm to 1×10¹⁵ Ω·cm, preferably 1×10⁹ Ω·cm to 1×10¹² Ω·cm.

### C. Seamless Belt

A seamless belt of the present invention includes the polyamide-imide resin film. The polyamide-imide resin film obtained by using the polyamide-imide resin composition has excellent dimensional stability in spite of the fact that the film contains the conductive filler. Further, the polyamide-imide resin film has excellent dimensional stability even under an environment where a humidity change may occur. Therefore, when the seamless belt of the present invention is used in, for example, any one of an intermediate transfer belt, fixing belt, and conveying belt of a copying machine or the like, the deformation of the belt such as the elongation or deflection of the belt in its rotation direction in the apparatus can be prevented from occurring owing to the expansion of the belt due to its moisture absorption. Accordingly, the seamless belt of the present invention can stably drive even under an environment where a humidity change may occur, and can maintain desired performance. When the seamless belt is used as, for example, an intermediate transfer belt to be placed in an image-forming apparatus, the belt prevents, for example, the occurrence of image density unevenness or a color shift, and can maintain good image-forming performance. The seamless belt of the present invention may include any appropriate other layer except the polyamide-imide resin film depending on applications. Examples of the appropriate other layer include an inorganic metal oxide thin layer for imparting abrasion resistance and a layer containing fluorine resin powder or ceramic powder for adjusting sliding property. In addition, when the seamless belt is used as a release belt, a release layer formed of a fluorine resin, a silicone rubber, or the like is given as an example thereof.

The thickness of the seamless belt can be appropriately set depending on applications and is typically 50 μm to 150 μm, more preferably 50 μm to 100 μm.

Hereinafter, the present invention is specifically described by way of examples. However, the present invention is by no means limited by these examples. It should be noted that the term “part (s)” means “part(s) by weight.”

### Synthesis Example 1

### Synthesis of Polyamide-Imide Resin

0.95 Mole of trimellitic anhydride (TMA) and 0.05 mole of a dimer acid (DIA) (manufactured by Croda Japan, trade name: PRIPOL 1009) as the acid components (A), 1.00 mole of 4,4′-diphenylmethane diisocyanate (MDI) as the polyisocyanate component (B), and 1,120 parts by weight of N-methyl-2-pyrrolidone (NMP) as a solvent were loaded into a four-necked flask equipped with a mechanical stirrer with a stirring blade, and then the mixture was subjected to a reaction at 120° C. for 2 hours. Next, 0.01 mole of diazabicycloundecene (DBU) as a catalyst was added to the resultant. The temperature was increased to 180° C. and then the mixture was subjected to a reaction for 3 hours to provide a polyamide-imide varnish (solid matter concentration: 30 wt %).

### Synthesis Example 2

### Synthesis of Polyamide-Imide Resin

A polyamide-imide varnish (solid matter concentration: 30 wt %) was obtained in the same manner as in Synthesis Example 1 except that: 0.90 mole of TMA and 0.10 mole of the DIA were used as the acid components (A); and 1,170 parts by weight of NMP were used.

### Synthesis Example 3

### Synthesis of Polyamide-Imide Resin

A polyamide-imide varnish (solid matter concentration: 30 wt %) was obtained in the same manner as in Synthesis Example 1 except that: 0.70 mole of TMA and 0.30 mole of the DIA were used as the acid components (A); and 1,780 parts by weight of NMP were used.

### Synthesis Example 4

### Synthesis of Polyamide-Imide Resin

A polyamide-imide varnish (solid matter concentration: 30 wt %) was obtained in the same manner as in Synthesis Example 1 except that 0.50 mole of TMA and 0.50 mole of the DIA were used as the acid components (A).

### Synthesis Example 5

### Synthesis of Polyamide-Imide Resin

A polyamide-imide varnish (solid matter concentration: 30 wt %) was obtained in the same manner as in Synthesis Example 1 except that: 1.00 mole of TMA was used as the acid components (A); and 1,060 parts by weight of NMP were used.

### Synthesis Example 6

### Synthesis of Polyamide-Imide Resin

A polyamide-imide varnish (solid matter concentration: 30 wt %) was obtained in the same manner as in Synthesis Example 1 except that 0.90 mole of TMA and 0.10 mole of sebacic acid were used as the acid components (A).

### Synthesis Example 7

### Synthesis of Polyamide-Imide Resin

A polyamide-imide varnish (solid matter concentration: 30 wt %) was obtained in the same manner as in Synthesis Example 1 except that 0.40 mole of TMA and 0.60 mole of the DIA were used as the acid components (A).

### Example 1

23.1 Parts by weight of a polyaniline in an emeraldine base state (manufactured by Panipol, trade name: Panipol PA) and 81.9 parts by weight of n-dodecylbenzenesulfonic acid as a dopant (manufactured by KANTO CHEMICAL CO., INC., pKa value=2.55) were mixed by using an AWATORI RENTARO (manufactured by THINKY CORPORATION, mixing mode) for 3 minutes. The resultant mixture was heated and kneaded with a LABOPLASTOMILL 50 MP (manufactured by Toyo Seiki Seisaku-Sho, Ltd.) at 180° C. for 30 minutes. The resultant kneaded product was dissolved in NMP so that its solid matter concentration became 5 wt %, followed by stirring with a stirrer for 2 hours. Thus, a polyaniline solution was obtained.

The polyaniline solution and the varnish obtained in Synthesis Example 1 were mixed so that the addition amount of the polyaniline became 2.5 parts by weight with respect to 100 parts by weight of the polyamide-imide resin (solid matter) in the varnish obtained in Synthesis Example 1. Thus, a polyamide-imide resin composition was obtained.

The resultant polyamide-imide resin composition was cast on a glass plate and then the resultant was subjected to initial drying at 80° C. for 30 minutes. Next, the dried product was subjected to a heating treatment at 200° C. for 30 minutes to provide a polyamide-imide resin film (thickness: 76 μm).

### Example 2

A polyamide-imide resin film (thickness: 76 μm) was obtained in the same manner as in Example 1 except that the varnish obtained in Synthesis Example 2 was used.

### Example 3

A polyamide-imide resin film (thickness: 78 μm) was obtained in the same manner as in Example 1 except that the varnish obtained in Synthesis Example 3 was used.

### Example 4

A polyamide-imide resin film (thickness: 77 μm) was obtained in the same manner as in Example 1 except that the varnish obtained in Synthesis Example 4 was used.

### Comparative Example 1

A polyamide-imide resin film (thickness: 77 μm) was obtained in the same manner as in Example 1 except that the varnish obtained in Synthesis Example 5 was used.

### Comparative Example 2

A polyamide-imide resin film (thickness: 83 μm) was obtained in the same manner as in Example 1 except that the varnish obtained in Synthesis Example 6 was used.

### Comparative Example 3

The same operations as those of Example 1 were performed except that the varnish obtained in Synthesis Example 7 was used. However, a film having a practically acceptable mechanical strength could not be obtained.

(Evaluation)

The polyamide-imide resin films obtained in the examples and the comparative examples were subjected to the following evaluations. Table 1 shows the results.

### (1) Hygroscopic Expansion Coefficient

A sample measuring 25 mm by 4 mm punched out of the polyamide-imide resin film obtained in each of the examples and the comparative examples was set in an apparatus for thermomechanical analysis whose chuck-to-chuck distance had been set to 20 mm (such as an apparatus available under the trade name “TMA 4000SA” from Bruker AXS). After that, the sample was sufficiently dried under an environment having a temperature of 30° C. and a humidity of 20% RH. Next, the humidity was increased to 80% RH and then the hygroscopic expansion coefficient was calculated from a dimensional change with respect to an initial length at the time of measurement under the following conditions according to the following equation. When the hygroscopic expansion coefficient is 70 ppm % RH or less, the film is excellent in dimensional stability even under an environment where a humidity change may occur. It should be noted that an influence of the thickness of the film on the hygroscopic expansion coefficient may be absent when the thickness falls within the range of the thicknesses of the films obtained in the examples and the comparative examples.

Measurement mode: A tension method
Tension load: 4 g
Measurement atmosphere: A temperature of 30° C. and a humidity of 80% RH
Measuring time: 660 minutes

Hygroscopic expansion coefficient=(elongation of sample/initial length of sample)/amount of humidity change

### (2) Surface Resistivity

The surface resistivity of each of the polyamide-imide resin films obtained in the examples and the comparative examples at 25° C. and 60% RH was measured with a Hiresta-UP MCP-HT450 (manufactured by Mitsubishi Chemical Analytech Co., Ltd., probe: URS) under the measurement conditions of an applied voltage of 500 V and 10 seconds. It should be noted that a value in the table represents a common logarithmic value.

TABLE 1

| | | | | | | Comparative | Comparative | Comparative |
|---|---|---|---|---|---|---|---|---|
| | | Example 1 | Example 2 | Example 3 | Example 4 | Example 1 | Example 2 | Example 3 |
| Loading ratio of | Trimellitic | 95 | 90 | 70 | 50 | 100 | 90 | 40 |
| acid component | anhydride | | | | | | | |
| [mol %] | Dimer acid | 5 | 10 | 30 | 50 | — | — | 60 |
| | Sebacic acid | — | — | — | — | — | 10 | — |
| Film | Hygroscopic | 70 | 68 | 34 | 29 | 81 | 75 | Unmeasurable |
| characteristic | expansion | | | | | | | |
| | coefficient | | | | | | | |
| | [ppm/% RH] | | | | | | | |
| | Surface | 9.9 | 10 | 12.3 | 13.4 | 13 | 10.7 | Unmeasurable |
| | resistivity | | | | | | | |
| | [log Ω/□] | | | | | | | |

As is apparent from Table 1, each of the polyamide-imide resin films of Examples 1 to 4 had a hygroscopic expansion coefficient of 70 ppm % RH or less and was hence excellent in dimensional stability. In addition, each of the films had a surface resistivity in the range of 1×10⁹Ω/□ to 1×10¹⁴Ω/□ and was hence applicable to an application where conductivity was required.

On the other hand, each of the polyamide-imide resin films of Comparative Examples 1 and 2 had a hygroscopic expansion coefficient in excess of 70 ppm % RH. Accordingly, each of the films is liable to deform under an environment where a humidity change may occur, and hence may be unable to maintain desired performance in various applications.

In addition, when the content of the dimer acid was excessively large (Comparative Example 3), sufficient polymerization reactivity could not be secured and hence a polyamide-imide resin film having a practically acceptable mechanical strength could not be obtained.

The polyamide-imide resin film of the present invention is used in any appropriate application. The polyamide-imide resin film of the present invention can be suitably used in, for example, a fixing belt, belt for a photosensitive member base material, intermediate transfer belt, conveying belt, and transfer fixing belt in an image-forming apparatus of an electrophotographic system such as a copying machine or a printer.

What is claimed is:

1. A polyamide-imide resin film, comprising:
a polyamide-imide resin; and
a conductive filler,
wherein:
the polyamide-imide resin is obtained by causing acid components (A) containing a dimer acid and a polyisocyanate component (B) to react with each other; and
a ratio of the dimer acid in the acid components (A) is 3 mol % to 55 mol %.

2. A polyamide-imide resin film according to claim 1, wherein the acid components (A) contain a hydrogenated dimer acid.

3. A polyamide-imide resin film according to claim 1, wherein the polyisocyanate component comprises an aromatic diisocyanate.

4. A polyamide-imide resin film according to claim 1, wherein the acid components (A) further contain a tricarboxylic anhydride and a ratio of the tricarboxylic anhydride in the acid components (A) is 90 mol % to 97 mol %.

5. A polyamide-imide resin film according to claim 1, wherein the conductive filler comprises a polyaniline.

6. A polyamide-imide resin film according to claim 1, wherein the film has a hygroscopic expansion coefficient of 70 ppm % RH or less.

7. A seamless belt, comprising the polyamide-imide resin film according to claim 1.
